(19) United States
(12) Patent Application Publication
(10) Pub. No.: US 2002/0195986 A1
(43) Pub. Date: Dec. 26, 2002

(54) Method and apparatus for connecting a converter to an asynchronous machine

(75) Inventors: Thilo Weigel, Erlangen (DE); Wolfgang Zelder, Erlangen (DE)

Correspondence Address: BAKER BOTTS L.L.P., 44TH FLOOR, 30 ROCKEFELLER PLAZA, NEW YORK, NY, 10112-4498, US

(73) Assignee: Siemens Aktiengesellschaft

(21) Appl. No.: 09/841,630

(22) Filed: Apr. 24, 2001

(30) Foreign Application Priority Data
Mar. 26, 2001 (DE) 101 148 10.0

(51) Int. Cl. H02P 1/24; H02P 1/42; H02P 3/18; H02P 5/28; H02P 7/36

(52) U.S. Cl. 318/727

(57) ABSTRACT

A method and apparatus for connecting a converter to an asynchronous machine whose rotor is rotating with respect to the stator before and/or during the connection at some unknown rotation speed is disclosed. According to the present invention, a current is forced to flow, a rotor flux model vector and a stator current model vector are calculated as a function of a stator voltage and of an estimated rotation speed value. An error (e) is determined as a function of these calculated values and of a determined actual stator current vector, and the estimated rotation speed value is changed in such a manner that the determined error turns to zero. A method and apparatus are thus obtained for connecting a converter to an asynchronous machine, with the estimated rotation speed value converging in a very short time, starting from an initial value, to the actual mechanical rotation speed.

### FIELD OF THE INVENTION

The present invention relates generally to an apparatus and method for connecting a converter to an asynchronous machine. In particular, the present invention relates to an apparatus and method for connecting a converter to an asynchronous machine whose rotor is rotating with respect to the stator before and/or during the connection at some unknown rotation speed.

### BACKGROUND OF THE INVENTION

Many asynchronous machines are fed via a converter where the asynchronous machine does not have a rotation speed sensor. This is problematic because connection to an asynchronous machine which is rotating at an unknown rotation speed is necessary in some applications.

Once an asynchronous machine has been switched off, the rotor flux decays exponentially with the rotor time constant. The rotor flux, therefore, needs to be built up before starting regulated operation. There cannot be any occurrence of disturbing torques during this process. Once the rotor flux has been built up once again, regulated or controlled normal operation can be resumed.

The process of magnetization of the asynchronous machine and the detection of the previously unknown rotation speed are referred to as an “acquisition process”. The shorter the time required for the acquisition process, the faster normal operation can be resumed.

A method and an apparatus for connecting a converter to an asynchronous machine are known from DE 199 19 752 C1. The various methods for acquisition of the data for an asynchronous machine are described in detail to this German Patent Specification. However, there exists a need for a more efficient acquisition process. DE 199 19 752 C1is based on the object of specifying a method which is intended to allow the acquisition process for an asynchronous machine to be carried out in a very short time without any residual flux. At the same time, the realization and implementation effort are intended to be as low as possible.

The method of DE 199 19 752 C1 is characterized in that a stator voltage vector which is applied to the terminals of the stator windings is determined by a control and regulation device. A stator current vector is determined from the current flowing through the stator windings, in that an estimated value or model value for the stator flux vector is determined from this stator voltage vector and stator current vector. The nominal value, whose magnitude can be predetermined, for the stator current vector is determined from this model value. The nominal value, determined in this way, for the stator current vector and the stator current vector as an actual value, are supplied to a current regulator for the control and regulation device. Then the current regulator produces a value for the stator voltage vector such that the actual stator current value is regulated at the nominal value.

A major feature of the method disclosed in DE 199 19 752 C1 is that the method does not require the calculation of the torque, the rotor flux or the torque or magnetization current. Only one current regulator is used for the stator current vector.

In order to achieve torque-free magnetization of the asynchronous machine, the stator current vector is forced to flow in such a manner that it is parallel to the stator flux vector. This stator flux vector represents a state variable, and is initialized with a start value at the commencement of the acquisition process. Torque-free acquisition is ensured only when the start value of the estimated stator flux vector matches the actual stator flux vector. This is achieved by ensuring that the asynchronous machine is demagnetized, so that the start value can be chosen to be zero. This ensures that a time condition is complied with after previously switching off the converter. However, there exists a need for a method and system more efficient in terms of acquisition time and acquisition accuracy.

### SUMMARY OF THE INVENTION

The present invention relates to an apparatus and method for connecting a converter to an asynchronous machine whose rotor is rotating with respect to the stator before and/or during the connection at some unknown rotation speed utilizing an improved acquisition time and acquisition accuracy.

In particular, the method and apparatus according to the present invention is based on the knowledge that the acquisition time and the acquisition accuracy of the acquisition process can be improved considerably by means of a complete machine monitor, which comprises a machine model and rotation speed adaptation. In this case, an error determined between a calculated stator current model vector and a determined actual stator current vector is used with the assistance of the calculated rotor flux model vector, for rotation speed adaptation. The adapted rotation speed is precisely equal to the unknown rotation speed of the asynchronous machine when the determined error is equal to zero.

Such rotation speed adaptation is known from WO 97/08819. The subject matter of this international Laid-Open Specification is a method and an apparatus for determining a rotation speed of a three-phase machine without a sensor and operated on a field-oriented basis. Whereas the present invention provides a method and apparatus for determining the rotation speed without any rotating sensor based on the fact that the torque of a three-phase machine in the technically usable range between the generator and motor stalling torque, with the supply voltage remaining unchanged, depends monotonally on the angle between the stator field and the rotor field. Starting from no load, this flux angle in asynchronous machines varies monotonally with the rotation speed difference, and in synchronous machines the rate of change of this angle varies. If the actual machine receives the same voltage as a machine model with the same system parameters, then the torques also match, provided the “rotor angular velocity” parameter in the model matches the true rotor angular velocity of the actual machine. If the rotor angular velocity of the actual machine then differs from the estimated rotor angular velocity, then its torques no longer match the torque of the machine model. In the above-mentioned Laid-Open Specification, the estimated value of the “rotor angular velocity” of the machine model is adjusted by a regulator such that the torques match once again. It is thus possible to determine the rotation speed of an asynchronous machine without a sensor and operated on a field-oriented basis.

The use of this method for rotation speed adaptation of an asynchronous machine without a sensor and operated on a field-oriented basis considerably reduces the acquisition process for acquisition of the data for an asynchronous machine rotating at any unknown rotation speed. Using this method according to the invention, it is possible for the acquisition time to be in the order of magnitude of 100 ms. Furthermore, the mechanical rotation speed of the asynchronous machine is determined exactly, since the estimated rotation speed value of the complete machine monitor converges.

The stator current which is forced to flow has an influence on the acquisition time. The greater its value, the shorter is the acquisition time.

In one embodiment of the present invention, the error between the stator current model vector and the stator current actual vector is determined by the addition of two error elements, which can each be weighted. Thus, it is possible not only to specify these weights such that they are fixed, but also to specify them such that they are dependent on the rotation speed adaptation. The choice of the weight for the error element influences the stability and the accuracy of the convergence of the estimated rotation speed value.

When switching from the acquisition mode to normal operation of the asynchronous machine, the calculated rotor flux model vector or the nominal stator voltage vector which is provided can also be used as a switching criterion, in addition to the determined error.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method step, and wherein:

FIG. 1 is a block diagram of an asynchronous machine without a sensor and operated on a field-oriented basis, with an apparatus for carrying out the method in accordance with an exemplary embodiment of the present invention;

FIG. 2 is a block diagram of the apparatus for carrying out the method in accordance with an exemplary embodiment of the present invention;

FIG. 3 is a block diagram of a complete machine model in accordance with an exemplary embodiment of the present invention; and

FIG. 4 is a block diagram of an exemplary embodiment of the transformation circuit of FIG. 3.

### DETAILED DESCRIPTION OF THE INVENTION

In the following description, vector variables are denoted by a “→”, model variables by a “ˆ ” and a complex-conjugate vector variable by a “*”. “ω” denotes the electrical angular velocity, from which the mechanical angular velocity Ω is determined, with the number of pole pairs “p” of the asynchronous machine. The vector variables are also represented partially broken down into their components. As long as these are stator-oriented variables, these components have “α” and “β” as an index. If, on the other hand, they are components oriented on the basis of the rotor flux, then these components have the indices “d” or “q”.

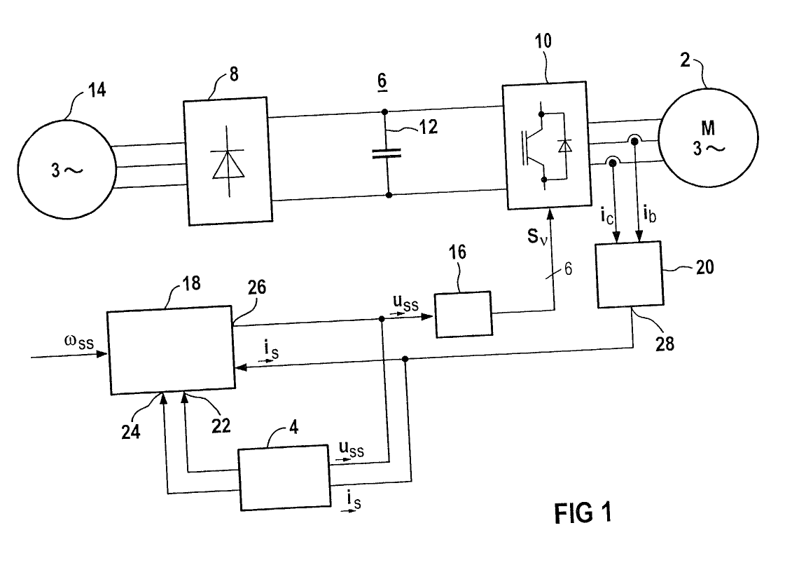

Now referring to the drawings, FIG. 1 illustrates a block diagram of an asynchronous machine 2 without a sensor and operated on a field-oriented basis. FIG. 1 also shows an apparatus 4 for connecting a converter 6 to the asynchronous machine 2. The converter 6, which on the mains side has a converter 8 operated as a rectifier and on the load side has a converter 10 operated as an inverter, converters 8 and 10 being connected to one another on the DC voltage side by means of a DC voltage intermediate circuit 12, is electrically conductively connected to a mains system 14. The asynchronous machine 2 is linked to the outputs of the converter 10 on the mains side. The converter 10 on the mains side is driven by a modulator 16 which, for its part, is supplied from a control and regulation device 18 with a nominal stator voltage vector

$${{u}_{\to }}_{SS} .$$

The modulator 16 converts this nominal stator voltage vector

$${{u}_{\to }}_{SS}$$

into control signals Sᵥ. The control and regulation device 18 receives an actual stator current vector

$${{i}_{\to }}_{S}$$

from a measured value device 20. This actual stator current vector

$${{i}_{\to }}_{S}$$

is generated from two measured phase currents i_{b} and i_{c}. For example, a nominal rotation speed value ωₛₛ is applied to the input of the control and regulation device 18. Apparatus 4, for connecting the converter 6 to the asynchronous machine 2, is connected on the output side to an angle input 22 and to a model input 24, and, on the input side, is connected to the control output 26 of the control and regulating device 18, and to the output 28 of the measured value device 20.

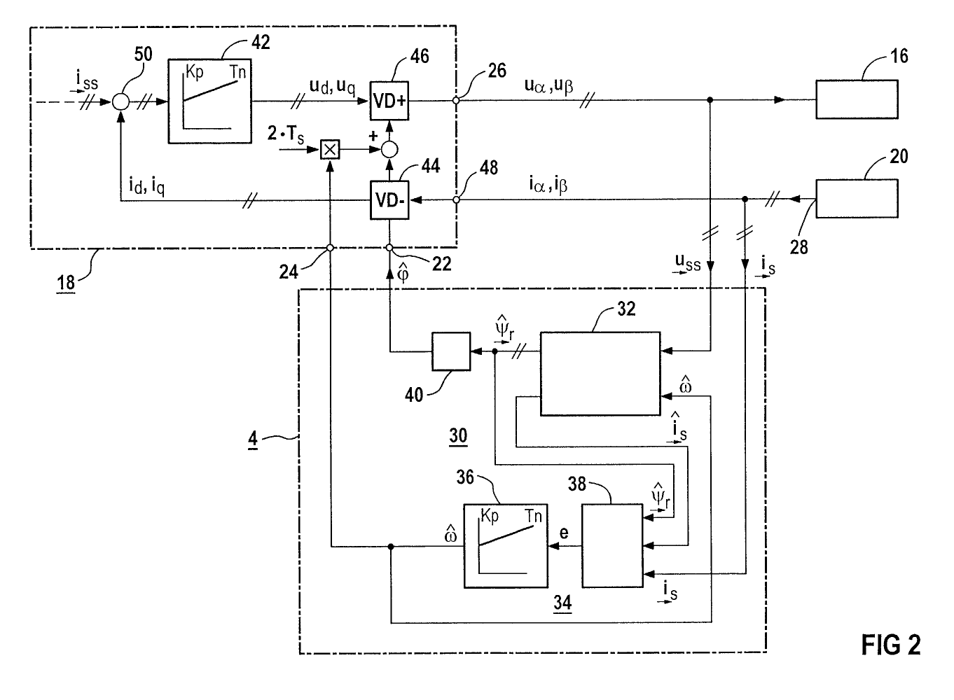

FIG. 2 illustrates a detailed block diagram of the apparatus 4 for connecting a converter 6 to the asynchronous machine 2 and that part of the control and regulation device 18 which is required for the acquisition mode. Apparatus 4 has a complete machine monitor 30, which comprises a machine model 32 and rotation speed adaptation 34. The machine model 32 is arranged on the input side such that a first input to machine model 32 is electrically conductively linked to the output 26 of the control and regulation device 18. The rotation speed adaptation 34 has a PI regulator 36 and a transformation device 38, which is connected upstream of the PI regulator 36. On the input side, the transformation circuit 38 is connected to the two outputs of the machine model 32, and to the output 28 of the measured value device 20. The output of the PI regulator 36 is linked to a second input of the machine model 32 and to the model input 24 of the control and regulation device 18. A first output of the machine model 32, at which a rotor flux model vector

$${{\hat{Ψ}}_{\to }}_{r}$$

is produced, is also connected by means of a device 40, for determining an angle position \hat{φ} of the rotor flux model vector

$${{\hat{Ψ}}_{\to }}_{r} ,$$

to the angle input 22 of the control and regulation device 18.

For simplicity of illustration, only a stator current regulator 42 and two vector rotators 44 and 46 of the control and regulation device 18 are shown in FIG. 2. The vector rotator 44 is connected downstream of the input 48 of the control and regulation device 18, and rotates the stator-oriented actual stator current vector i_{α}, i_{β} in an actual stator current vector i_{d}, i_{q}, which is rotor-flux oriented. This transformed rotor-flux-oriented actual stator current vector i_{d}, i_{q} is connected to an inverting input of a complex comparator 50, to whose non-inverting input a predetermined rotor-flux-oriented nominal stator current vector

$${{i}_{\to }}_{SS}$$

is applied. A downstream stator current regulator 42 uses the determined control errors of the current components i_{ds}, i_{qs}, i_{d}, i_{q} to generate stator voltage components u_{d} and u_{q} of a rotor-flux-oriented nominal stator voltage vector

$${{u}_{\to }}_{SS} .$$

By means of the downstream vector rotator 46 downstream stator current regulator 42 transforms this into a stator-oriented nominal stator voltage vector u_{α}, u_{β}. The two stator voltage components u_{α} and u_{β} are supplied to the modulator 16. For transformation of the stator-oriented actual stator current vector i_{α}, i_{β} in a rotor-flux-oriented actual stator current vector i_{d}, i_{q}, the vector rotator 44 requires the angular position \hat{φ} of the rotor flux ψᵣ of the asynchronous machine 2. Since the rotor flux ψᵣ cannot be measured, the angular position \hat{φ} of the calculated rotor flux model vector

$${{\hat{Ψ}}_{\to }}_{r}$$

is supplied to the vector rotator 44. The vector rotator 46 is rotated through one value with respect to the vector rotator 44. This value is the product of the rotation speed model value \hat{ω} and twice the sampling time Tₛ. If the apparatus 4 for connection is not activated, then the rotation speed model value \hat{ω} is connected to an actual value input of a rotation speed regulator, which is not illustrated, in the control and regulation device 18, and the value for the rotation is then obtained from the product of twice the sampling time Tₛ and the stator frequency fₛ, which is generated by the control and regulation device 18 itself.

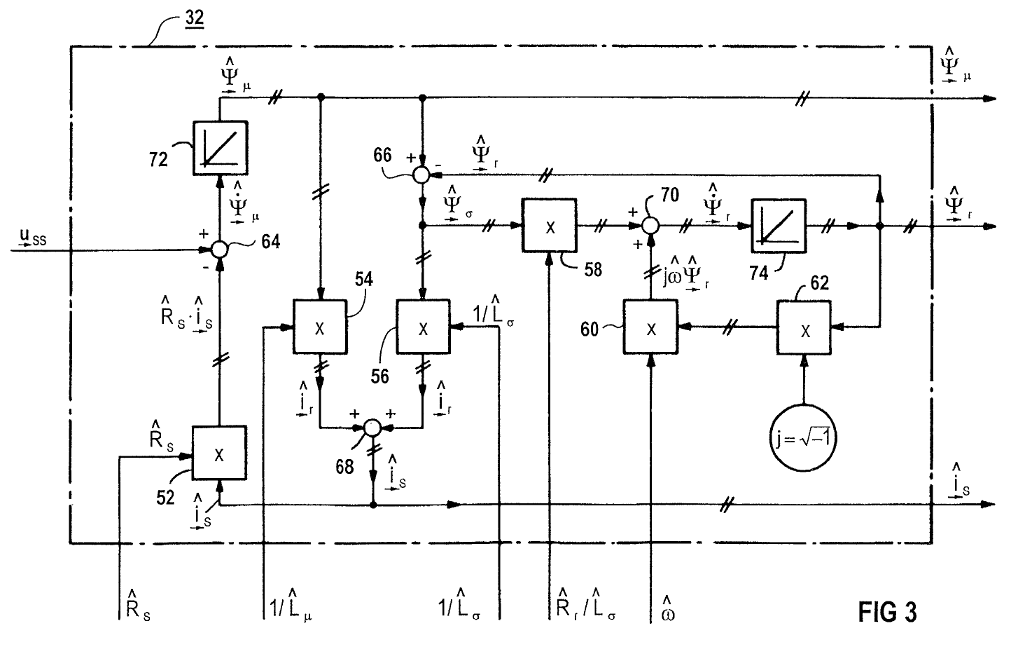

FIG. 3 illustrates a detailed block diagram of a complete machine model 32 which is known from the international Laid-Open Specification WO

97/08819 cited above. The complete machine model 32 has a number of multipliers 52, 54, 56, 58, 60 and 62, two comparators 64 and 66, two adding elements 68 and 70 and two integrating elements 72 and 74. This complete machine model 32 is supplied with two input variables, namely a nominal stator voltage vector

$${{u}_{\to }}_{SS}$$

and an estimated rotation speed value \hat{ω}, and with system parameters comprising the stator resistance Rₛ, rotor resistance Rᵣ, magnetization inductance L_{μ} and stray inductance L_{σ}. The complete machine model 32 uses these predetermined values to calculate the vectors for the stator flux chain ψ_{μ}, the rotor flux chain ψᵣ, and the stator current iₛ. Since the complex-conjugate rotor flux chain ψ_{μ}, is used for the method according to the present invention, the specific rotor flux chain ψᵣ must be converted to a complex-conjugate flux chain ψ_{μ}.

As can be seen from FIG. 3, the input side of multiplier 52 is connected to an input for the parameter Rₛ of the machine model 32 and to a comparator 64, and the output side of multiplier 52 is connected to an output of the adding element 68. The nominal stator voltage vector

$${{u}_{\to }}_{SS}$$

is applied to the non-inverting input of the comparator 64. On the output side of multiplier 52 comparator 64 is connected via a first integrating element 72 to the multiplier 54, to a non-inverting input of the comparator 66, and to an output of the machine model 32. On the output side the multiplier 54 is connected to the adding element 68, whose second input is linked by means of the multiplier 56 to the output of the comparator 66 and by means of a further multiplier 58, to an input of a further adding element 70. A parameter, namely the stator resistance Rₛ comprising the reciprocal value of the magnetization inductance L_{μ} and the reciprocal value of the stray inductance L_{σ} are respectively applied to the second inputs of the multipliers 52, 54 and 56. On the output side, the adding element 70 is linked by means of a further integrating element 74 to the inverting input of the comparator 66 and to an output of the machine model 32 and, by means of a series circuit of two multipliers 62 and 60, to the second input of the adding element 70. The factor “j” is applied to the second input of the multiplier 62, and the estimated rotation speed value \hat{ω} is applied to the second input of the multiplier 60. The output of the adder 68, at which the stator current model vector

$${{\hat{i}}_{\to }}_{S}$$

is produced, is also connected to a further output of the complete machine model 32. The complete machine model 32, which is known, can be used to calculate, as a function of the nominal stator voltage vector

$${{u}_{\to }}_{SS}$$

for the load-side converter 10 and an estimated rotation speed value \hat{ω}, the rotor flux chain

$${{\hat{Ψ}}_{\to }}_{r}$$

of the asynchronous machine 2, and the stator current model vector

$${{\hat{i}}_{\to }}_{S} .$$

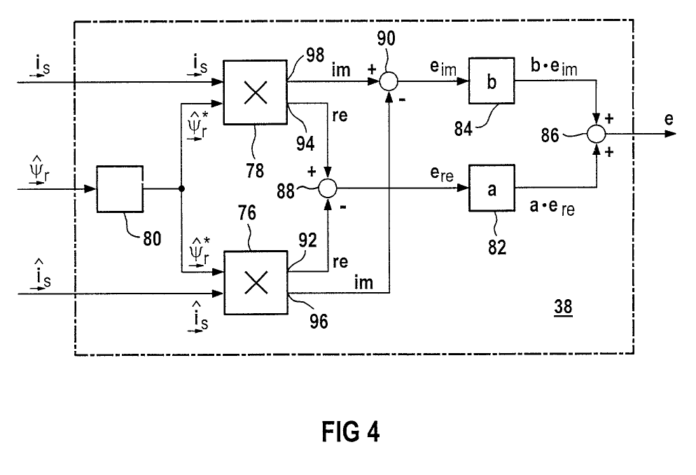

FIG. 4 illustrates in more detail an exemplary embodiment of the transformation device 38 of the apparatus 4 for connection. On the input side, this transformation device 38 has two complex multiplication elements 76 and 78 and a device 80 for forming a complex-conjugate vector, and on the output side it has two weighting elements 82 and 84, whose outputs are each connected to one input of an adding element 86. The determined error e is produced at the output of the adding element 86 and is supplied to the PI regulator 36 for the rotation speed regulator adaptation 34. The two multiplication elements 76 and 78 and the two weighting elements 82 and 84 are linked to one another by means of two subtraction elements 88 and 90. In this embodiment, the real component outputs 92 and 94 are connected to the inputs of the subtraction element 88. The imaginary component outputs 96 and 98 of the two multiplication elements 76 and 78 are linked to the inputs of the second subtraction element 90. The output of the first subtraction element 88 is connected to the input of the first weighting element 82 while, in contrast, the output of the second subtraction element 90 is connected to the input of the second weighting element 84. One input of each of the two multiplication elements 76 and 78 is connected to the output of the device 80 for forming a complex-conjugate vector, to whose input the calculated rotor flux model vector

$${{\hat{Ψ}}_{\to }}_{r}$$

is applied. By means of the device 80, this rotor flux model vector

$${{\hat{Ψ}}_{\to }}_{r}$$

is used to obtain the complex-conjugate rotor flux model vector

$${{\hat{Ψ}}_{\to }}_{r}^{*}$$

The calculated stator current model vector

$${{\hat{i}}_{\to }}_{s}$$

and the determined actual stator current vector

$${{i}_{\to }}_{s}$$

are applied to the second input of the respective multiplication element 76 or 78. This embodiment of the transformation device 38 implements the following equation:

$$\begin{matrix}e = T ( Re \{ ( {{i}_{s}}_{->} - {{\hat{i}}_{s}}_{->} ) \cdot {{\hat{Ψ}}_{r}^{*}}_{->} \} Im \{ ( {{i}_{s}}_{->} - {{\hat{i}}_{s}}_{->} ) \cdot {{\hat{Ψ}}_{r}^{*}}_{->} \} ) \\ = a \cdot Re \{ ( {{i}_{s}}_{->} - {{\hat{i}}_{s}}_{->} ) \cdot {{\hat{Ψ}}_{r}^{*}}_{->} \} + b \cdot Im \{ ( {{i}_{s}}_{->} - {{\hat{i}}_{s}}_{->} ) \cdot {{\hat{Ψ}}_{r}^{*}}_{->} \}\end{matrix}$$

The multiplication of the actual stator current vector

$${{\hat{i}}_{\to }}_{S}$$

and the stator current model vector

$${{\hat{i}}_{\to }}_{S}$$

by the complex-conjugate rotor flux model vector

$${{\hat{Ψ}}_{\to }}_{r}^{*}$$

is used to project the actual stator current vector

$${{i}_{\to }}_{S}$$

and the stator current model vector

$${{\hat{i}}_{\to }}_{S}$$

onto the rotor flux model vector. In the subtraction process, the real components and the imaginary components of the projected actual stator current vector

$${{i}_{\to }}_{S}$$

and of the projected stator current model vector

$${{\hat{i}}_{\to }}_{S}$$

are then subtracted from one another. The two results of these calculations are a real component error “eᵣₑ” and an imaginary component error “eᵢₘ”, which are added to form the total error “e”. The two weighting elements 82 and 84 allow the real component error “eᵣₑ” and the imaginary component error “eᵢₘ” to be weighted separately. One possible weighting is for the weighting factor “a” to be chosen to be equal to zero, and for the weighting factor “b” to be chosen to be equal to unity. This choice of the weighting factors “a” and “b” results in the acquisition process having improved stability. It is also possible to vary at least one weighting factor “a” or “b” as a function of the operating point. Such weighting as a function of the operating point is obtained using the following equation:

$$a = \frac{π}{2} \cdot {( \frac{\hat{ω}}{{\hat{ω}}_{start}} )}^{2} \cdot sign ( {\hat{ω}}_{start} )$$

The method according to another exemplary embodiment of the present invention for connection of a converter 6 to an asynchronous machine 2 will now be described in more detail with reference to the described figures:

In the event of a fault in the drive, the modulator 16 of the converter 6 is inhibited, as a result of which the converter 6 no longer supplies the connected asynchronous machine 2. If the pulse inhibit is once again cancelled after this, the converter 6 must be reconnected to the asynchronous machine 2. Since the asynchronous machine 2 has no rotation speed sensor, the control and regulation device 18 does not know the operating state of the asynchronous machine 2. For this reason, the apparatus 4 for connecting the converter 6 to the asynchronous machine 2 is then activated. When this activation of the apparatus 4 for connection takes place, the rotation speed model value \hat{ω} is set to a predetermined value \hat{ω}ₛₜₐᵣₜ, for example to the maximum model value \hat{ω}. Furthermore, the value of the nominal stator current value

$${{i}_{\to }}_{SS}$$

is set to a predetermined value. For example, this value may be equal to the rated value. Setting the nominal stator current value

$${{i}_{\to }}_{SS}$$

forces this current to flow in the asynchronous machine 2. Since the rotation speed model value \hat{ω}ₛₜₐᵣₜ which has been set has in the mean time been released once again, its convergence process starts. In this exemplary embodiment, the rotation speed model value \hat{ω} is varied as a function of the error “e” determined between the stator current model vector

$${{\hat{i}}_{\to }}_{S}$$

and the actual stator current vector

$${{i}_{\to }}_{S} ,$$

in such a way that the error “e” is regulated to be zero. As soon as the error “e” is zero, the mechanical rotation speed Ω of the real machine is identified. The time which is required for this identification process is in the order of magnitude of 100 ms. Within this time, the mechanical rotation speed Ω of the actual asynchronous machine 2 changes only insignificantly. As soon as the error “e” has become zero, the system switches back to the control and regulation device 18, which uses the adapted rotation speed model value \hat{ω} in its rotation speed regulation. The estimated rotor flux

$${\hat{Ψ}}_{r}$$

or the machine voltage U₁ applied to the input of the modulator 16 can also be used as a switching criterion. In this case, these values are compared with predetermined limit values, with the apparatus 4 for connection being switched off when these limit values are reached.

The method and apparatus in accordance with the present invention results in the estimated value of the mechanical rotation speed converging from an initial value \hat{ω}ₛₜₐᵣₜ in a very short time with the mechanical rotation speed Ω of the actual asynchronous machine 2, thus, providing a more efficient acquisition process.

Although the present invention has been described in detail with reference to specific exemplary embodiments thereof, various modifications, alterations and adaptations may be made by those skilled in the art without departing from the spirit and scope of the invention. It is intended that the invention be limited only by the appended claims.

We claim:

1. (Amended) A method for connecting a converter to an asynchronous machine whose rotor is rotating with respect to the stator before and/or during connection at some unknown rotation speed, said method comprising:
forcing a predetermined nominal stator current value to flow into said asynchronous machine;
determining an actual stator current vector from a current flowing through stator windings;
calculating a stator current model vector and a rotor flux model vector from a nominal stator voltage vector which is applied to terminals of said stator windings and from a set rotation speed model value;
determining any error between said stator current model vector and said determined actual stator current vector by means of said calculated rotor flux model vector; and
changing said rotation speed model value in such a manner that the determined error is regulated to be zero.

2. (Amended) The method as claimed in claim 1, wherein a change is made from the acquisition mode to normal operation as a function of said calculated rotor flux model vector and a predetermined rotor flux limit vector.

3. (Amended) The method as claimed in claim 1, wherein a change is made from the acquisition mode to normal operation as a function of said nominal stator voltage vector and a predetermined voltage limit vector.

4. (Amended) The method as claimed in claim 1, 2 or 3, wherein determining said actual stator current vector and calculating said stator current model vector are each multiplied by said flux model vector, with real and imaginary components of calculated products each being compared with one another, and error elements being added to form said error.

5. (Amended) The method as claimed in claim 4, wherein said error elements are each multiplied by weighting factors.

6. (Amended) The method as claimed in claim 5, wherein said weighting factors are dependent on an operating point.

7. (Amended) The method as claimed in claim 1, wherein said rotation speed model value is set to the maximum value.

8. (Amended) The method as claimed in claim 1, wherein a value of said nominal stator current value, which is forced to flow, is chosen to be as high as possible.

9. (Amended) An apparatus for connecting a converter to an asynchronous machine whose rotor is rotating with respect to the stator before and/or during connection at some unknown rotation speed, said apparatus comprising:
a complete machine monitor, said complete machine monitor comprising:
a machine model; and
a rotation speed adaptor, said rotation speed adaptor having a rotation speed adaption regulator; and
a device for determining an error with an input side of said rotation speed adaption regulator, said rotation speed adaption regulator being connected to an output of said device for determining said error and an output of said speed adaption regulator being connected to an input of said machine model and to one input in each case of two vector rotators of a control and regulation circuit for said converter, and wherein an input side of said device is linked to outputs of said machine model and to a measured value device, and with one output of said control and regulation circuit being connected to a further input of the machine model.

10. (Amended) The apparatus as claimed in claim 9, wherein said device comprises two complex multipliers and two subtraction elements, wherein a first input of a first multiplier and a second input of the second multiplier are linked to an output of a device for forming a complex-conjugate vector, and wherein a second input of said first multiplier are linked to a second output of said machine model, and a first input of a second multiplier being linked to an output of said measured value device, wherein a first and a second output of each of said two multipliers each are connected to one input of a first and of a second subtraction element, and wherein said outputs of the two subtraction elements are linked to inputs of an adder.

11. (Amended) The apparatus as claimed in claim 10, wherein said subtraction elements are each followed on said output side by a weighting element, and said outputs of these weighting elements are connected to said inputs of said adder.

12. (Amended) The apparatus as claimed in claim 9, further comprising a microprocessor.
